(19) United States
(12) Patent Application Publication
(10) Pub. No.: US 2026/0203959 A1
(43) Pub. Date: Jul. 16, 2026

(54) SUBJECT-DRIVEN GENERATION OF SYNTHESIZED IMAGES

(71) Applicant: Bytedance Technology Ltd., Grand Cayman (KY)

(72) Inventors: Hao KANG, Los Angeles, CA (US); Efstathios Fotiadis, Los Angeles, CA (US); Xin Lu, Los Angeles, CA (US); Yumin Jia, Los Angeles, CA (US); Liming Jiang, Los Angeles, CA (US); Qing Yan, Los Angeles, CA (US); Min Jin Chong, Los Angeles, CA (US); Zichuan Liu, Los Angeles, CA (US)

(21) Appl. No.: 19/094,404

(22) Filed: Mar. 28, 2025

Related U.S. Application Data
(60) Provisional application No. 63/745,681, filed on Jan. 15, 2025.

(51) Int. Cl. G06T 11/00; G06T 3/4038; G06T 5/60; G06T 5/77

(52) U.S. Cl. CPC G06T 11/00; G06T 3/4038; G06T 5/60; G06T 5/77; G06T 2207/20084

(57) ABSTRACT

A computing system is provided for generating a synthesized image using subject-driven text-to-image generation. The computing system includes a processing circuitry and memory storing instructions that, when executed, cause the processing circuitry to receive one or more input images of a subject and a user prompt, generate a mosaic of two or more component images based on the one or more input images and the user prompt, generate a mask to mark a placeholder area in the mosaic to be inpainted, use a generative model to inpaint the placeholder area, extract the inpainted placeholder area to generate an extracted image of the subject, and output the extracted image of the subject as the synthesized image.

### CROSS REFERENCE TO RELATED APPLICATIONS

This application claims priority to Application No. 63/745,681, filed Jan. 15, 2025, the entirety of which is hereby incorporated herein by reference for all purposes.

### BACKGROUND

Text-to-image generation is a machine learning technique that generates images based on textual input describing the image to be generated. Text-to-image generation techniques have been applied in fields ranging from personalized content creation to entertainment and education. Despite these advances, there remain technical challenges for existing text-to-image generation techniques, particularly when tasked with subject-driven text-to-image generation, which synthesizes images of a specific subject in various contexts based on a text prompt and one or more reference images, while maintaining a similar visual appearance to the specific subject across diverse contextual scenarios in alignment with the text prompt.

Existing text-to-image generation systems can be broadly categorized into methods requiring extensive fine-tuning of underlying models and those attempting to achieve generation with minimal or zero additional training of a pre-trained model. One existing approach leverages grid prompting techniques for subject-driven generation. However, these systems often rely on fine-tuning text-to-image diffusion models, a process that introduces computational overhead and limits adaptability to new subjects or contexts. This reliance on model fine-tuning also makes such systems less practical for applications demanding on-the-fly personalization.

Another noteworthy prior approach achieves zero-shot inpainting with text-to-image models, utilizing a single reference image to condition the generation process. While promising in reducing the need for fine-tuning, these systems often require an auxiliary inpainting model to ensure output consistency. Furthermore, their reliance on single-view reference inputs restricts the applicability to scenarios requiring multi-view or diverse subject representations. These limitations pose challenges for generating complex scenes or ensuring subject fidelity in various contexts.

Overall, existing solutions struggle with two interrelated technical challenges: (1) the preservation of visual similarity of the subject across varying contextual transformations, and (2) achieving alignment between the textual prompt and the synthesized image without additional computational costs, such as fine-tuning or auxiliary model training. These challenges are particularly pronounced when dealing with complex scenes involving multiple objects or nuanced transformations of the subject.

### SUMMARY

In view of the above issues, a computing system is provided for generating a synthesized image using subject-driven text-to-image generation. The computing system includes a processing circuitry and memory storing instructions that, when executed, cause the processing circuitry to receive one or more input images of a subject and an input prompt, generate a mosaic of two or more component images based on the one or more input images and the input prompt, generate a mask to mark a placeholder area in the mosaic to be inpainted, use a generative model to inpaint the placeholder area, extract the inpainted placeholder area to generate an extracted image of the subject, and output the extracted image of the subject as the synthesized image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the mosaic generator of the computing system of FIG. 1.

FIG. 3 illustrates a detailed schematic of an example of the inputs and outputs of the language model of the mosaic generator of FIG. 2.

FIG. 4 illustrates a detailed schematic of a first example of the inputs and outputs of the vision language model and the image augmentation module of the mosaic generator of FIG. 2.

FIG. 5 illustrates a detailed schematic of a second example of the inputs and outputs of the vision language model and the image augmentation module of the mosaic generator of FIG. 2.

FIG. 6 illustrates a detailed schematic of the inputs and outputs of the mask generator of the mosaic generator of FIG. 2.

FIG. 7 illustrates a detailed schematic of the inputs and outputs of the generative model and image extractor of the machine learning image generator of FIG. 1.

FIG. 8 is a flow chart of a first method for generating a synthesized image according to an example embodiment of the present disclosure.

FIG. 9 is a flow chart of a second method for generating a synthesized image according to an example embodiment of the present disclosure.

FIG. 10 is a flow chart of a third method for generating an inpainted image using a cascade attention mechanism according to an example embodiment of the present disclosure.

FIG. 11 shows an example computing environment of the present disclosure in which the first computing system of FIG. 1 may be enacted.

### DETAILED DESCRIPTION

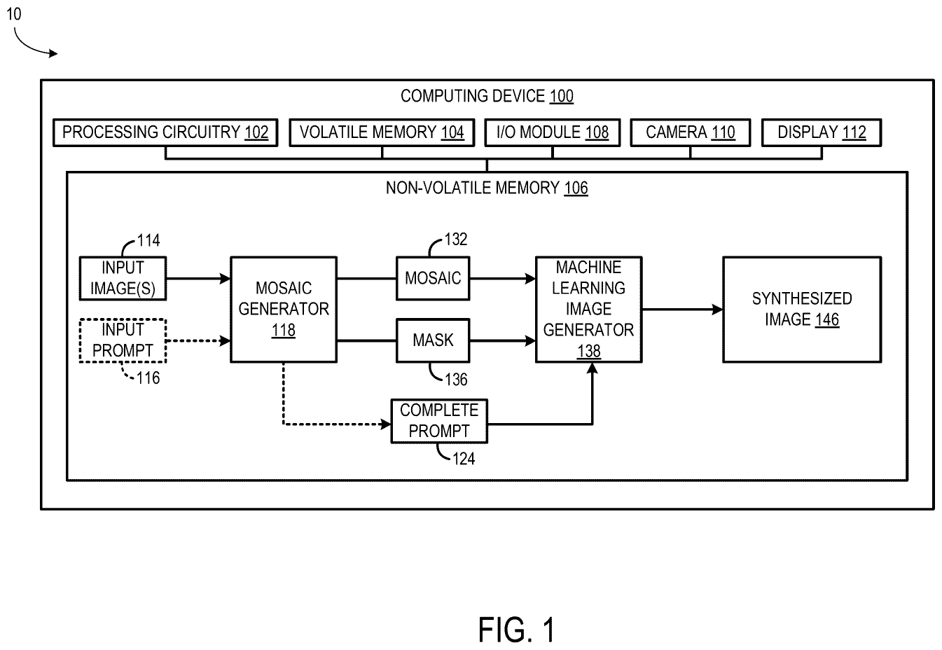

FIG. 1 shows a schematic view of an example computing system 10 including a computing device 100 for generation of a synthesized image 146 using subject-drive text-to-image generation. The system 10 uses a mosaic generator 118 and a machine learning image generator 138. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions for the processing circuitry 102 to execute the mosaic generator 118 which is configured to receive one or more input images 114 of a subject and an input prompt 116, 124 and generate a mosaic 132 of two or more component images based on the one or more input images 114, and further generate a mask 136 to mark a placeholder area in the mosaic 132 to be inpainted.

In one embodiment, a user provides a complete prompt 124, which is subsequently inputted into the machine learning image generator 138 along with the mosaic 132 and the mask 136 to generate the synthesized image 146. In an alternative embodiment, a user provides an input prompt 116, which is subsequently inputted into the mosaic generator 118 along with the one or more input images 114 to generate a mosaic 132, a mask 136, and a complete prompt 124. The mosaic 132, the mask 136, and the complete prompt 124 that are generated by the mosaic generator 118 are subsequently inputted into the machine learning image generator 138 to generate the synthesized image 146.

The processing circuitry 102 further executes a machine learning image generator 138 which receives the mosaic 132 and the mask 136 as input, uses a generative model to inpaint the placeholder area, extract the inpainted placeholder area to generate an extracted image 146 of the subject, and output the extracted image 146 of the subject as the synthesized image 146.

For example, the synthesized image 146 may be outputted for rendering on the display 112 and/or encoded by a video encoder to generate and output a video stream incorporating the synthesized image 146. The synthesized image 146 may be published or shared on a social network platform for viewing by other users of the social network platform.

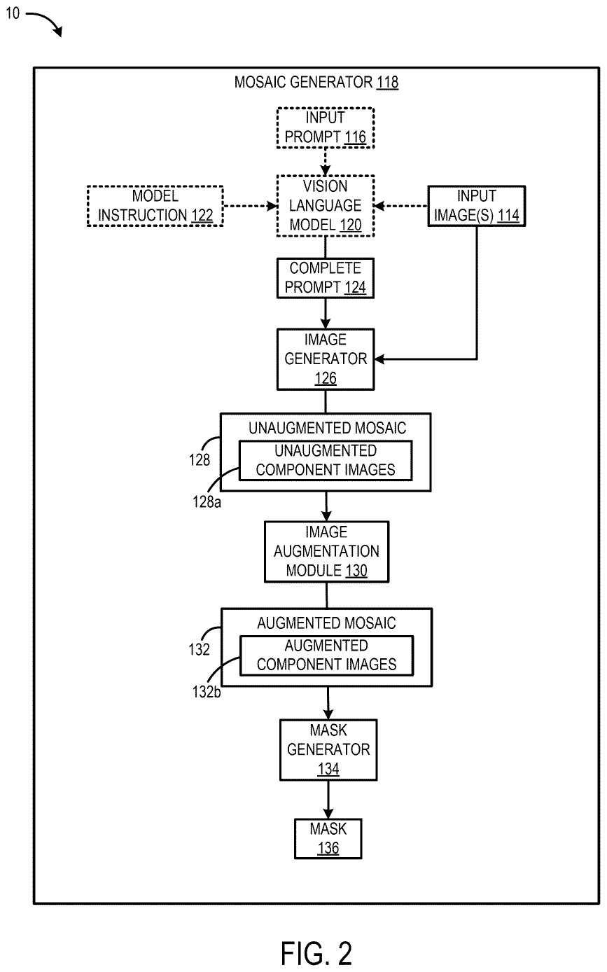

FIG. 2 shows a detailed schematic view of the processes of the mosaic generator 118 of FIG. 1 from receiving the input prompt 116 to generating the mosaic 132 and the mask 136. The mosaic generator 118 may include a vision language model 120 which is configured to receive the one or more input images 114, the input prompt 116, and a model instruction 122, and generate a complete prompt 124 based on the input prompt 116 and the model instruction 122. The input prompt 116 may specify the context in which the specific subject of the one or more input images 114 is to be rendered, and the model instruction 122 may provide a detailed description of the mosaic 132 to be generated. The specific subject may be a person, object, or other entity of interest.

The mosaic generator 118 also includes an image generator 126 which is configured to receive the complete prompt 124 and the one or more input images 114 as input, and generate an unaugmented mosaic 128 comprising two or more unaugmented component images 128a. The unaugmented mosaic 128 may be an image comprising a grid of component images 128a, where all the component image 128a are identical to each other. The configuration of the grid is not particularly limited, and the component images 128a may be arranged in various configurations, including 3×3, 1×2, 1×4, 2×2, and 4×4, for example. Alternatively, each component image 128a may represent the specific subject from different perspectives, which may include, but are not limited to the front view, side views, top view, bottom view, and angled side views. The component images 128a may be arranged in a sequential order specified by the complete prompt 124. The grid includes a placeholder area which will be inpainted by the machine learning image generator 138.

It will be appreciated that, although the vision language model 120 is depicted as generating the complete prompt 124 in the example of FIG. 2, the vision language model 120, the model instruction 122, and the input prompt 116 may be alternatively omitted in other embodiments, in which the user provides the complete prompt 124 instead of the input prompt 116.

The image augmentation module 130 processes the unaugmented mosaic 128 to generate an augmented mosaic 132 comprising two or more augmented component images 132b. In the augmented mosaic 132, each augmented component image 132b is a transformed version of the corresponding component image 128a in the unaugmented mosaic 128. The image augmentation module 130 applies one or more transformations to each component image 128a in the unaugmented mosaic 128. The one or more transformations may include rotations, scaling, flipping, shearing, and perspective transformations, for example. Rotations may adjust the orientation of the component image 128a by rotating it around its center point. Scaling may resize the component image 128a by increasing or decreasing its dimensions while maintaining or altering its aspect ratio.

A mask generator 134 generates a binary mask 136 marking a placeholder area 132a in the mosaic 132 which is to be inpainted. The location or position of the placeholder area 132a in the mask 136 is not particularly limited, and may be in a corner or a center of the mask 136, for example.

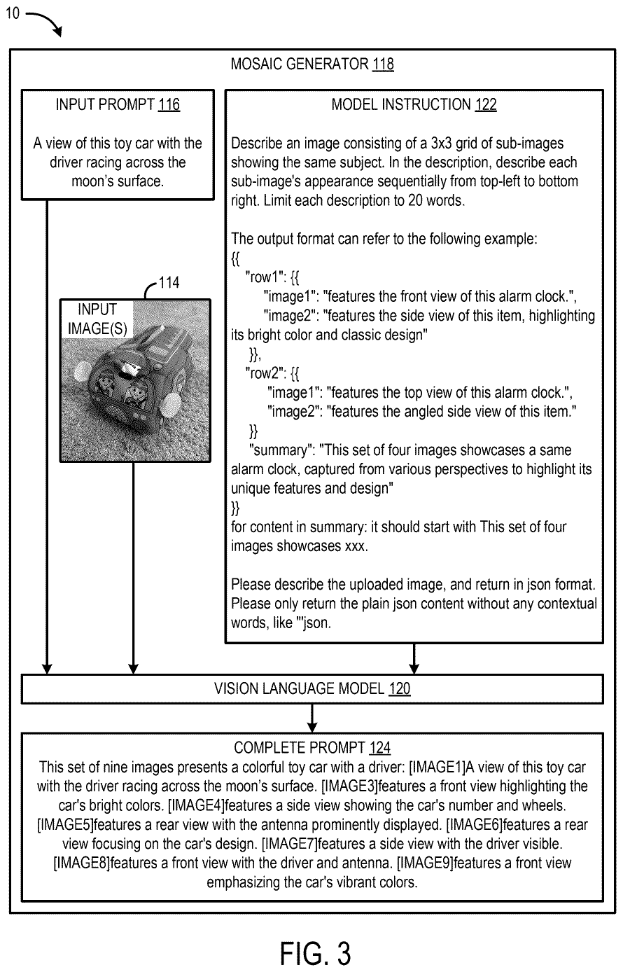

Turning to FIG. 3, an example of the one or more input images 114, the input prompt 116, and model instruction 122 that may be inputted and the complete prompt 124 that may be outputted by the vision language model 120 of FIG. 2 is depicted in detail. In this example, the input image 114 depicts a toy car, and the input prompt 116 specifies, “A view of this toy car with the driver racing across the moon's surface.” The model instruction 122 provides guidance, such as “Describe an image consisting of a 3×3 grid of sub-images showing the same subject. In the description, describe each sub-image's appearance sequentially from top-left to bottom-right. Limit each description to 20 words.” These inputs 114, 116, 122 guide the vision language model 120 to generate a structured complete prompt 124 which adheres to the spatial and descriptive requirements specified by the input prompt 116 and the model instruction 122.

In accordance with the inputs 114, 116, 122, the vision language model 120 generates the complete prompt 124 which serves as a basis for the image generator 126 to generate a mosaic 128. For the provided example, the complete prompt 124 would specify the details of each sub-image in the 3×3 grid. The generated descriptions might include: “features a view of this toy car with the driver racing across the moon's surface,” “features a front view highlighting the car's bright colors,” “features a side view showing the car's number and wheels,” and so on. The complete prompt 124 describes each component image sequentially from the top-left to the bottom-right of the grid, providing comprehensive coverage of the subject from various perspectives.

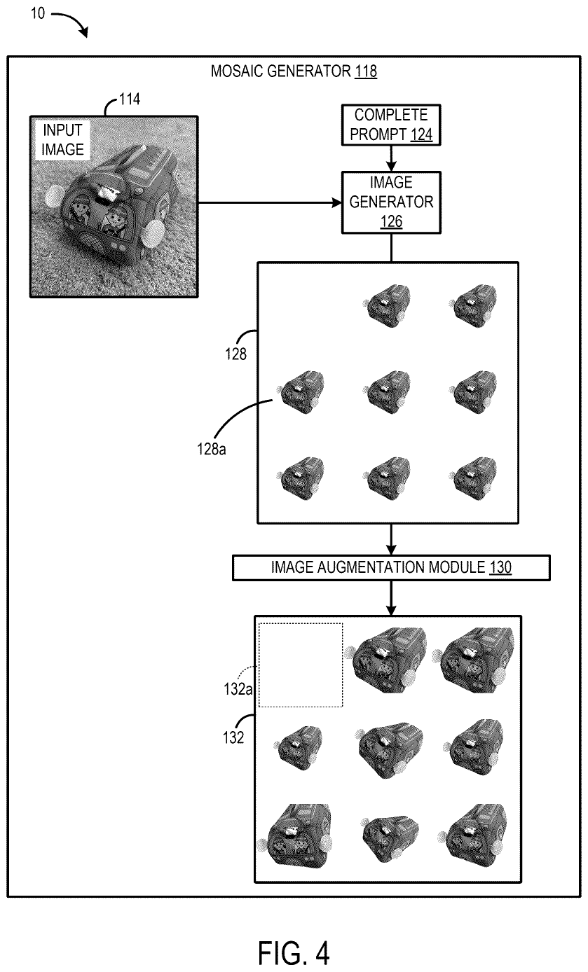

Turning to FIG. 4, a first example illustrates an input image 114 that may be inputted into the image generator 126 to generate the unaugmented mosaic 128 and, subsequently, the augmented mosaic 132 through the image augmentation module 130, as shown in FIG. 2. In the first example, the input image 114 is a single image of a toy car as the subject, which is to be rendered in the synthesized image.

The image generator 126 is configured to receive the complete prompt 124 and the input image 114 of the toy car as input, and generate an unaugmented mosaic 128 comprising a grid of identical toy car images as component images 128a. The image augmentation module 130 subsequently processes the unaugmented mosaic 128 to apply one or more transformations to each component image 128a in the unaugmented mosaic 128 to generate the augmented mosaic 132. The one or more transformations include rotations and scaling. The augmented mosaic 132 includes a placeholder area 132a designated for future inpainting.

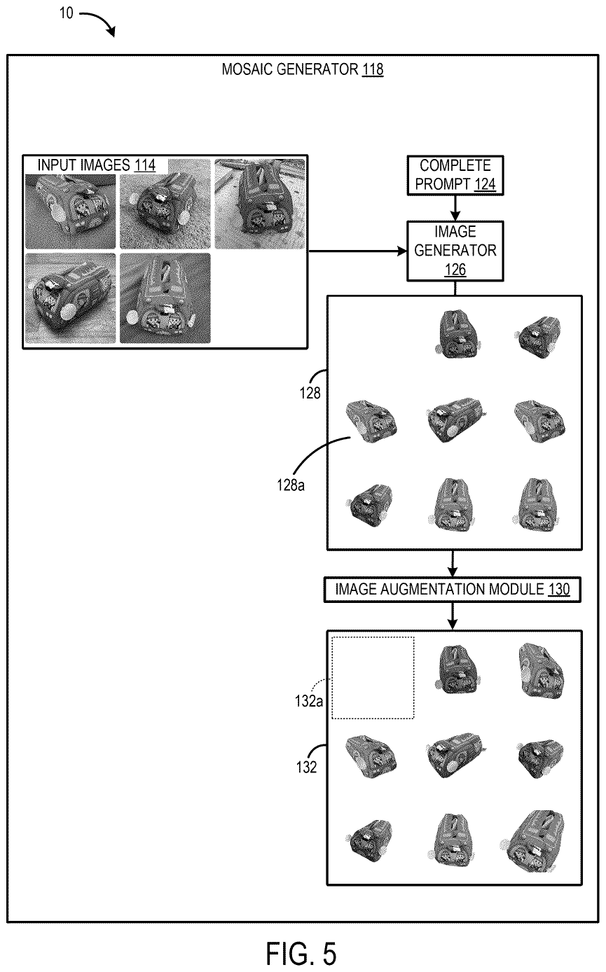

Referring to FIG. 5, a second example illustrates input images 114 that can be processed by the image generator 126 to generate an unaugmented mosaic 128 and, subsequently, an augmented mosaic 132 through the image augmentation module 130, as shown in FIG. 2. In this example, five input images 114 depict the subject, a toy car, to be rendered in the synthesized image.

The image generator 126 receives the complete prompt 124 and the five input images 114 as input. The image generator 126 generates an unaugmented mosaic 128, which comprises a grid of component images 128a depicting the toy car. Each component image 128a is extracted from the input images 114, with the backgrounds replaced by a white background to isolate the subject in each image. The image augmentation module 130 then processes the unaugmented mosaic 128, applying one or more transformations—such as rotations and scaling—to each component image 128a, resulting in the augmented mosaic 132. The augmented mosaic 132 also includes a placeholder area 132a designated for future inpainting.

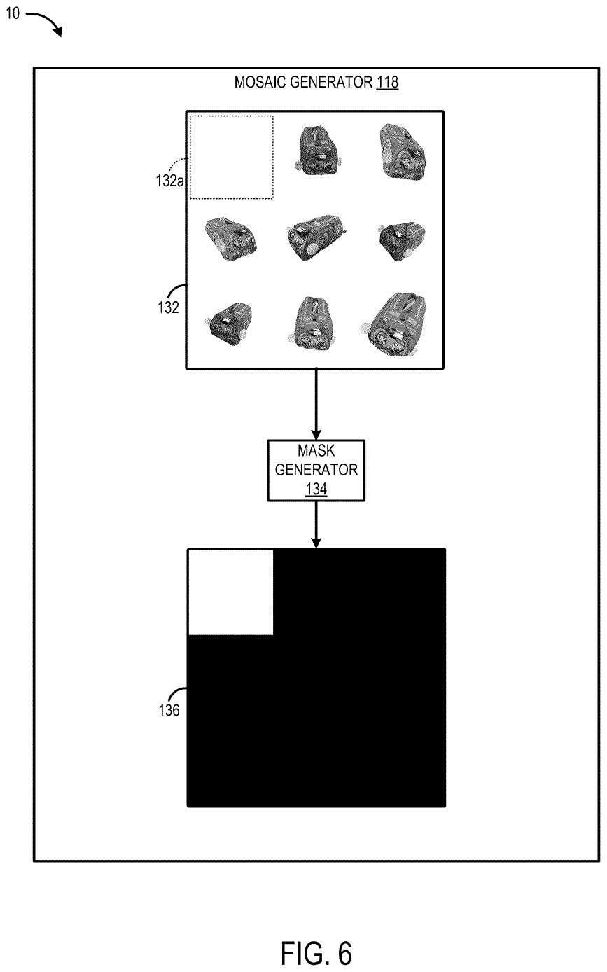

Referring to FIG. 6, the second example of FIG. 5 further depicts an augmented mosaic 132 containing a placeholder area 132a, which can be processed by the mask generator 134 to create a mask 136. The mask 136 is designed to designate the placeholder area 132a for inpainting. The dimensions of the mask 136 match those of the augmented mosaic 132. This binary mask marks the placeholder area 132a with a value of ‘zero’ and marks all other areas of the augmented mosaic 132 with a value of ‘one,’ effectively isolating the placeholder area 132a for subsequent inpainting.

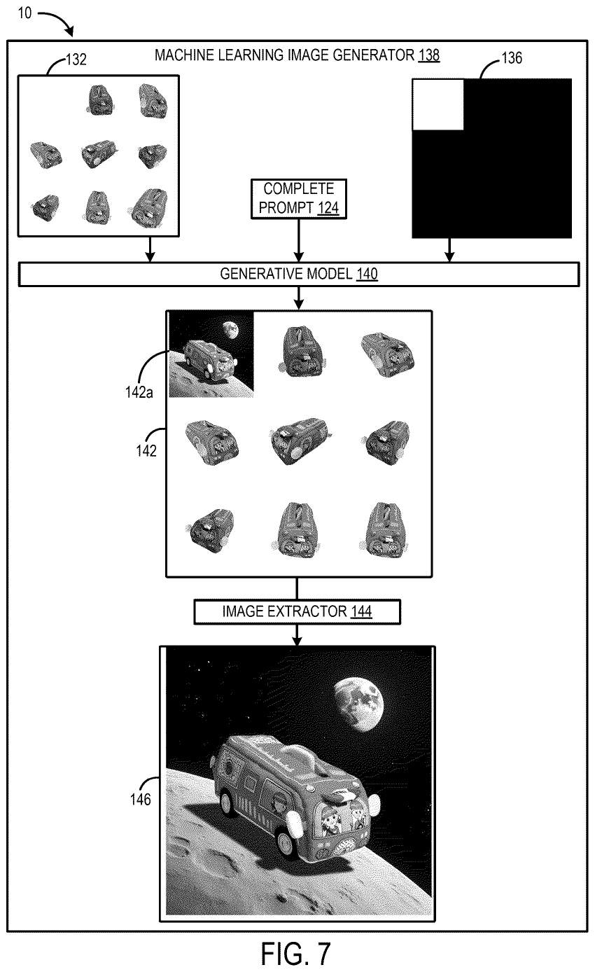

Referring to FIG. 7, the second example of FIGS. 5 and 6 further depicts the generation of the synthesized image 146 by the generative model 140 receiving the complete prompt 124, the augmented mosaic 132, and the binary mask 136 as input. The generative model 140 generates an inpainted mosaic 142 with an inpainted image 142a replacing the placeholder area 132a of the augmented mosaic 132. In this example, the inpainted image 142a is that of a toy car with the driver racing across the moon's surface, in alignment with the complete prompt 124. The image extractor 144 subsequently isolates and extracts the inpainted image 142a to generate and output the final synthesized image 146.

The generative model 140 may be implemented as a diffusion model that iteratively refines the placeholder area 132a to generate the inpainted image 142a. This process uses the following formula to replace the masked area's noise latent with the corresponding time-step latents of the input reference image, performing denoising at each step: L′=(1−M)⊙L+M⊙L_{cond} (Formula 1).

In Formula 1, M represents the binary mask 136, where a value of 0 designates the placeholder area 132a for inpainting, and a value of 1 corresponds to the area outside the placeholder. L is the latent of the entire image denoised from the previous step, while L_{cond} represents the latents of the augmented mosaic 132 with added noise, serving as the mosaic condition adjusted for the current time step. L′ is the noise latent of the entire image, including the updated placeholder area, which will undergo further denoising in subsequent steps.

Alternatively, the generative model 140 may utilize diffusion inversion techniques to create the inpainted image 142a. When configured to use diffusion inversion techniques, the generative model 140 may employ a zero-shot conditional sampling algorithm based on Rectified Flows (RFs), which use an Ordinary Differential Equation known as reverse ODE. To initialize the process, a controlled forward ODE is constructed, starting from the augmented mosaic 132, including the placeholder area 132a. This forward ODE generates the initial conditions required for the reverse ODE.

The reverse ODE is then guided by an optimal controller, obtained through solving a Linear Quadratic Regulator (LQR) problem. The process ensures that the inpainting of the placeholder area 132a is both contextually coherent with the surrounding mosaic and aligned with the prompt's semantic content.

Alternatively, the generative model 140 may use a cascade attention mechanism to generate the inpainted image 142a, using an iterative mechanism which looks at the reference subject at different scales. Instead of relying solely on a single fine-scale representation, pooled (downsampled) versions of queries and keys are constructed to capture a more global view of the subject. These pooled attention score maps are then upsampled and added back to the original fine-scale score map which is the original pooled attention score map before unsampling. Accordingly, a consistent subject identity can be maintained while refining details across all sub-images.

Assuming the generative model 140 has one attention head, the original queries and keys of the generative model 140 would be defined by the following formula:

$${Q}_{1} ∈ {ℝ}^{n \times d} , {K}_{1} ∈ {ℝ}^{n \times d} \qquad ( Formula 2 )$$

In Formula 2, the queries (Q₁) and keys (K₁) are represented by matrices with n rows and d columns. In the matrix for the keys, each row corresponds to a key vector of hidden dimension d. Likewise, in the matrix for the queries, each row corresponds to a query vector of hidden dimension d. Each row n of the matrix for the queries is defined by the Formula 3:

$$n = M \cdot \frac{H}{p} \cdot N \cdot \frac{w}{p} \qquad ( Formula 3 )$$

In Formula 3, p is the attention patch size, H is the height of the latent, and W is the width of the latent. M and N define the height and width of the M×N grid of sub-images. In the M×N grid, each image has a resolution of H×W.

To incorporate broader context, pooled queries and keys {Qᵢ, Kᵢ} are defined, for i=2, . . . . I, by average-pooling along the spatial dimension: Qᵢ=pool (Qᵢ₋₁), Kᵢ=pool (Kᵢ₋₁) (Formula 4)

Then attention score maps are constructed for each layer and pooled together to generate a pooled attention score map:

$${S}_{i}^{P} = {Q}_{i} {K}_{i}^{T} ∈ {ℝ}^{\frac{n}{i} \times \frac{n}{i}} \qquad ( Formula 5 )$$

In Formula 5,

$${S}_{i}^{P}$$

is the pooled attention score map, computed as a dot product between queries Qᵢ and the transpose of keys Kᵢ, resulting in a square matrix of size n/i×n/i, where i≥2. The pooled attention score map is then bilinearly upsampled to

$${S}_{i}^{U}$$

where i≥2 of size n×n. Then the upsampled maps are added into the original pooled attention score map to obtain a cascaded attention map S, which is expressed by the following formula:

$$S = softmax ( {S}_{1}^{U} + {\sum }_{i = 2}^{I} ( {S}_{i}^{U} [ {Q}_{target} , {K}_{reference} ] ) ) \qquad ( Formula 6 )$$

In Formula 6, [Q_{target}, K_{reference}] indicates that only the slice of the pooled attention score map corresponding to the target queries (Q_{target}) and reference keys (K_{reference}) is updated.

$${S}_{1}^{U}$$

is the original pooled attention score map or original fine-scale map before upsampling,

$${\sum }_{i = 2}^{l} ( {S}_{i}^{U} [ {Q}_{target} , {K}_{reference} ] )$$

represents the aggregation of additional context scores as a result of bilinear upsampling, and the softmax function normalizes the final combined attention scores.

Accordingly, the generative model 140 may use a coarse-scale “big picture” of the subject, and then reinsert clues at fine resolution to maintain consistent identity across multiple sub-images. Differences in positional encodings between the queries, keys, and their pooled versions may introduce slight variations, helping preserve subtle details, which may include facial or body features of the subject. This may result in a stronger alignment between reference images and newly generated sub-images, delivering sharp details in the generated images.

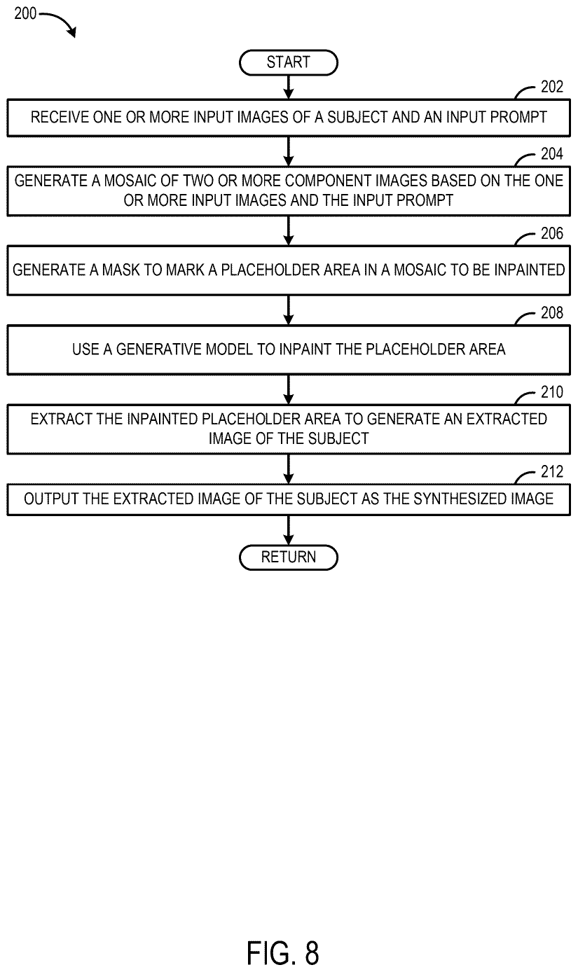

FIG. 8 shows a process flow diagram of a first example method 200 for generating a synthesized image. The first example method 200 may be executed by the processing circuitry 102 and memory 104 of the computing system 10 of FIG. 1. The first example method 200 includes, at step 202, receiving one or more input images of a subject and an input prompt. The first example method 200 includes, at step 204, generating a mosaic of two or more component images based on the one or more input images and the input prompt. At step 206, the method 200 includes generating a mask to mark a placeholder area in a mosaic to be inpainted. At step 208, the method 200 includes using a generative model to inpaint the placeholder area. At step 210, the method 200 includes extracting the inpainted placeholder area to generate an extracted image of the subject. At step 212, the method includes outputting the extracted image of the subject as the synthesized image.

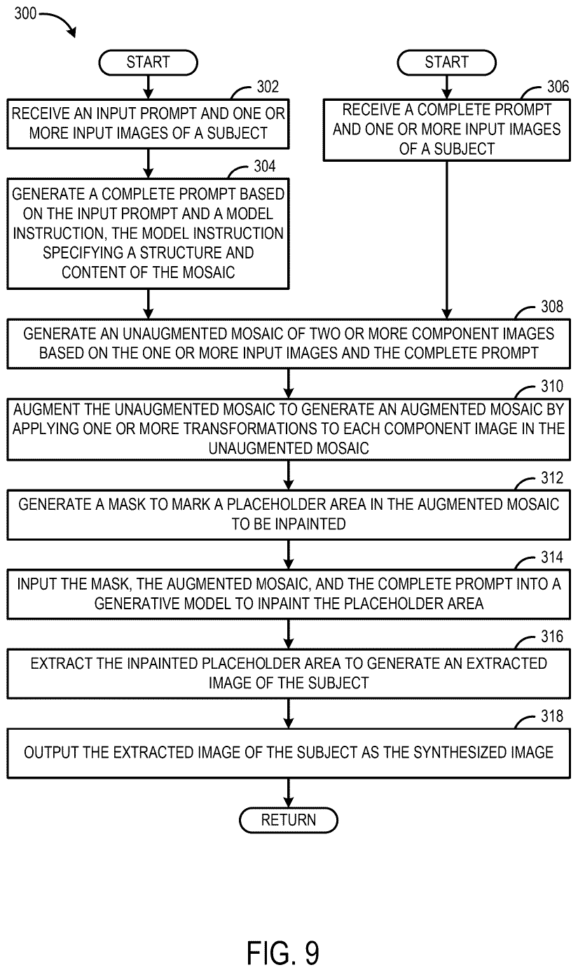

FIG. 9 shows a process flow diagram of a second example method 300 for generating a synthesized image. The second example method 300 may be executed by the processing circuitry 102 and memory 104 of the computing system 10 of FIG. 1. The second method 300 may start at step 302, receiving one or more input images of a subject and an input prompt, then at step 304, generating a complete prompt based on the input prompt and a model instruction, the model instruction specifying a structure and content of the mosaic, and then proceeding to step 308. Alternatively, the second method 300 may start at step 306, receiving a complete prompt and one or more input images of a subject, and then proceeding to step 308.

At step 308, the method 300 includes generating an unaugmented mosaic of two or more component images based on the one or more input images and the complete prompt. At step 310, the method 300 includes augmenting the unaugmented mosaic to generate an augmented mosaic by applying one or more transformations to each component image in the unaugmented mosaic. At step 312, the method 300 includes generating a mask to mark a placeholder area in the augmented mosaic to be inpainted.

At step 314, the method 300 includes inputting the mask, the augmented mosaic, and the complete prompt into a generative model to inpaint the placeholder area. At step 316, the method 300 includes extracting the inpainted placeholder area to generate an extracted image of the subject. At step 318, the method 300 includes outputting the extracted image of the subject as the synthesized image.

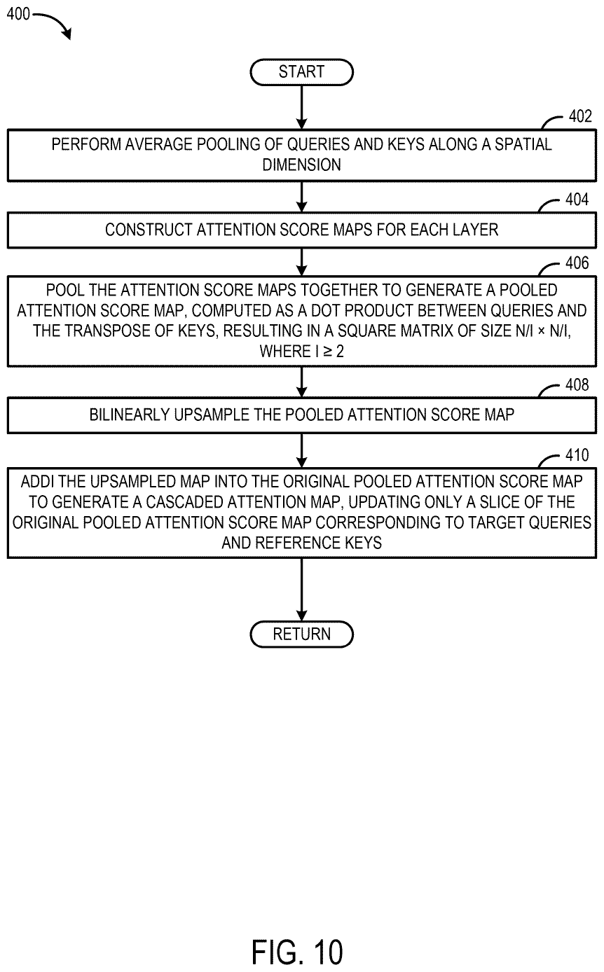

FIG. 10 shows a process flow diagram of a third example method 400 for generating an inpainted image using a cascade attention mechanism. The third example method 400 may be executed by the generative model 140 of FIG. 7. The second method 400 may start at step 402, performing average pooling of queries and keys along a spatial dimension. The method 400 includes step 404 of constructing attention score maps for each layer, and step 406 of pooling the attention score maps together to generate a pooled attention score map, computed as a dot product between queries and the transpose of keys, resulting in a square matrix of size n/i×n/i, where i≥2. The method 400 further includes step 408 of bilinearly upsampling the pooled attention score map. At step 410, the method 400 includes adding the upsampled map into the original pooled attention score map to generate a cascaded attention map, updating only a slice of the original pooled attention score map corresponding to target queries and reference keys.

As described throughout herein, by applying a novel approach to subject-driven text-to-image generation which involves inpainting a placeholder area of a mosaic, high fidelity in subject identity preservation can be achieved while maintaining flexibility and alignment with textual prompts and obviating the need for additional training or auxiliary models. Accordingly, new opportunities personalized content creation may be opened by combining adaptability, precision, and efficiency.

In some embodiments, the methods and processes described herein may be tied to a computing system of one or more computing devices. In particular, such methods and processes may be implemented as a computer-application program or service, an application-programming interface (API), a library, and/or other computer-program product.

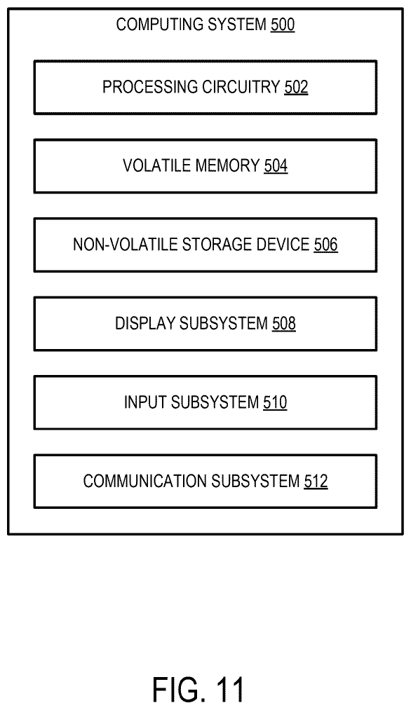

FIG. 11 schematically shows a non-limiting embodiment of a computing system 500 that can enact one or more of the methods and processes described above. Computing system 500 is shown in simplified form. Computing system 500 may embody the computing system 10 described above and illustrated in FIG. 1. Components of computing system 500 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 500 includes processing circuitry 502, volatile memory 504, and a non-volatile storage device 506. Computing system 500 may optionally include a display subsystem 508, input subsystem 510, communication subsystem 512, and/or other components not shown in FIG. 11.

Processing circuitry 502 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 502 may be single-core or multi-core, and the instructions executed thereon may be configured for sequential, parallel, and/or distributed processing. Individual components of the processing circuitry 502 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 502.

Non-volatile storage device 506 includes one or more physical devices configured to hold instructions executable by the processing circuitry 502 to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by processing circuitry 502 to temporarily store information during processing of software instructions. It will be appreciated that volatile memory 504 typically does not continue to store instructions when power is cut to the volatile memory 504.

Aspects of processing circuitry 502, volatile memory 504, and non-volatile storage device 506 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via processing circuitry 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with processing circuitry 502, volatile memory 504, and/or non-volatile storage device 506 in a shared enclosure, or such display devices may be peripheral display devices.

The following paragraphs provide additional description of the subject matter of the present disclosure.

One aspect provides a computing system for generating a synthesized image using subject-driven text-to-image generation, the computing system comprising processing circuitry and memory storing instructions that, when executed, cause the processing circuitry to receive one or more input images of a subject and an input prompt, generate a mosaic of two or more component images based on the one or more input images and the input prompt, generate a mask to mark a placeholder area in a mosaic to be inpainted, use a generative model to inpaint the placeholder area, extract the inpainted placeholder area to generate an extracted image of the subject, and output the extracted image of the subject as the synthesized image. In this aspect, additionally or alternatively, the generative model may be a diffusion model. In this aspect, additionally or alternatively, the diffusion model may iteratively refine the placeholder area by replacing a noise latent of the placeholder area with time-step latents of the mosaic to be inpainted. In this aspect, additionally or alternatively, the generative model may use the formula L′=(1−M)⊙L+M⊙L_{cond}, where L′ represents an updated noise latent, M is the mask, L is a denoised latent from a previous step, and L_{cond} represents noise-adjusted latents of the mosaic to be inpainted. In this aspect, additionally or alternatively, the generative model may use a diffusion inversion technique to inpaint the placeholder area. In this aspect, additionally or alternatively, the generative model may use the diffusion inversion technique based on Rectified Flows, employing a reverse Ordinary Differential Equation (ODE) to generate the inpainted placeholder area. In this aspect, additionally or alternatively, the generative model may use a cascade attention mechanism to inpaint the placeholder area. In this aspect, additionally or alternatively, a complete prompt may be generated based on the input prompt and a model instruction, the model instruction may specify a structure and content of the mosaic. In this aspect, additionally or alternatively, the complete prompt may describe each component image in the mosaic sequentially. In this aspect, additionally or alternatively, the mosaic may comprise a grid of component images, and each component image may represent a subject from a different perspective. In this aspect, additionally or alternatively, the mosaic may be an unaugmented mosaic, an augmented mosaic may be generated by applying one or more transformations to the component images of the unaugmented mosaic, and the placeholder may be in the augmented mosaic.

Another aspect provides a computing method for generating a synthesized image using subject-driven text-to-image generation, the computing method comprising receiving one or more input images of a subject and an input prompt, generating a mosaic of two or more component images based on the one or more input images and the input prompt, generating a mask to mark a placeholder area in a mosaic to be inpainted, using a generative model to inpaint the placeholder area, extracting the inpainted placeholder area to generate an extracted image of the subject, and outputting the extracted image of the subject as the synthesized image. In this aspect, additionally or alternatively, the generative model may be a diffusion model. In this aspect, additionally or alternatively, the diffusion model may iteratively refine the placeholder area by replacing a noise latent of the placeholder area with time-step latents of the mosaic to be inpainted. In this aspect, additionally or alternatively, the generative model may use the formula L′=(1−M)⊙L+M⊙L_{cond}, where L′ represents an updated noise latent, M is the mask, L is a denoised latent from a previous step, and L_{cond} represents noise-adjusted latents of the mosaic to be inpainted. In this aspect, additionally or alternatively, the generative model may use a diffusion inversion technique to inpaint the placeholder area. In this aspect, additionally or alternatively, the generative model may use the diffusion inversion technique based on Rectified Flows, employing a reverse Ordinary Differential Equation (ODE) to generate the inpainted placeholder area. In this aspect, additionally or alternatively, the generative model may use a cascade attention mechanism to inpaint the placeholder area. In this aspect, additionally or alternatively, a complete prompt may be generated based on the input prompt and a model instruction, the model instruction may specify a structure and content of the mosaic. In this aspect, additionally or alternatively, the complete prompt may describe each component image in the mosaic sequentially. In this aspect, additionally or alternatively, the mosaic may comprise a grid of component images, and each component image may represent a subject from a different perspective. In this aspect, additionally or alternatively, the mosaic may be an unaugmented mosaic, an augmented mosaic may be generated by applying one or more transformations to the component images of the unaugmented mosaic, and the placeholder may be in the augmented mosaic.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a synthesized image using subject-driven text-to-image generation, the computing system comprising:
processing circuitry and memory storing instructions that, when executed, cause the processing circuitry to:
receive one or more input images of a subject and an input prompt;
generate a mosaic of two or more component images based on the one or more input images and the input prompt;
generate a mask to mark a placeholder area in a mosaic to be inpainted;
use a generative model to inpaint the placeholder area;
extract the inpainted placeholder area to generate an extracted image of the subject; and
output the extracted image of the subject as the synthesized image.

2. The computing system of claim 1, wherein the generative model is a diffusion model.

3. The computing system of claim 2, wherein the diffusion model iteratively refines the placeholder area by replacing a noise latent of the placeholder area with time-step latents of the mosaic to be inpainted.

4. The computing system of claim 3, wherein the generative model uses the formula L′=(1−M)⊙L+M⊙L_{cond}, wherein L′ represents an updated noise latent, M is the mask, L is a denoised latent from a previous step, and L_{cond} represents noise-adjusted latents of the mosaic to be inpainted.

5. The computing system of claim 1, wherein the generative model uses a diffusion inversion technique to inpaint the placeholder area.

6. The computing system of claim 5, wherein the generative model uses the diffusion inversion technique based on Rectified Flows, employing a reverse Ordinary Differential Equation (ODE) to generate the inpainted placeholder area.

7. The computing system of claim 1, wherein the generative model uses a cascade attention mechanism to inpaint the placeholder area.

8. The computing system of claim 1, wherein
a complete prompt is generated based on the input prompt and a model instruction;
the model instruction specifies a structure and content of the mosaic.

9. The computing system of claim 8, wherein the complete prompt describes each component image in the mosaic sequentially.

10. The computing system of claim 1, wherein
the mosaic comprises a grid of component images; and
each component image represents a subject from a different perspective.

11. The computing system of claim 1, wherein
the mosaic is an unaugmented mosaic;
an augmented mosaic is generated by applying one or more transformations to the component images of the unaugmented mosaic; and
the placeholder is in the augmented mosaic.

12. A computing method for generating a synthesized image using subject-driven text-to-image generation, the computing method comprising:
receiving one or more input images of a subject and an input prompt;
generating a mosaic of two or more component images based on the one or more input images and the input prompt;
generating a mask to mark a placeholder area in a mosaic to be inpainted;
using a generative model to inpaint the placeholder area;
extracting the inpainted placeholder area to generate an extracted image of the subject; and
outputting the extracted image of the subject as the synthesized image.

13. The computing method of claim 12, wherein the generative model is a diffusion model.

14. The computing method of claim 13, wherein the diffusion model iteratively refines the placeholder area by replacing a noise latent of the placeholder area with time-step latents of the mosaic to be inpainted.

15. The computing method of claim 14, wherein the generative model uses the formula L′=(1−M)⊙L+M⊙L_{cond}, wherein L′ represents an updated noise latent, M is the mask, L is a denoised latent from a previous step, and L_{cond} represents noise-adjusted latents of the mosaic to be inpainted.

16. The computing method of claim 12, wherein the generative model uses a cascade attention mechanism to inpaint the placeholder area.

17. The computing method of claim 12, wherein
a complete prompt is generated based on the input prompt and a model instruction;
the model instruction specifies a structure and content of the mosaic.

18. The computing method of claim 17, wherein the complete prompt describes each component image in the mosaic sequentially.

19. The computing method of claim 12, wherein
the mosaic comprises a grid of component images; and
each component image represents a subject from a different perspective.

20. The computing method of claim 12, wherein
the mosaic is an unaugmented mosaic;
an augmented mosaic is generated by applying one or more transformations to the component images of the unaugmented mosaic; and
the placeholder is in the augmented mosaic.
